(19) United States
(12) Patent Application Publication
(10) Pub. No.: US 2008/0140513 A1
(43) Pub. Date: Jun. 12, 2008

(54) CONSUMER DRIVEN PRODUCT ANALYSIS AND PRODUCTION SYSTEM

(76) Inventor: Michael Walden, Broomall, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/966,380

(22) Filed: Dec. 28, 2007

Related U.S. Application Data
(63) Continuation of application No. 10/031,680, filed on Jul. 30, 2002, now abandoned.
(60) Provisional application No. 60/145,150, filed on Jul. 22, 1999.
(60) Provisional application No. 60/145,153, filed on Jul. 22, 1999.

(51) Int. Cl. G06Q 30/00; G06Q 10/00

(52) U.S. Cl. 705/10; 705/14

(57) ABSTRACT

A system and computer implemented method for promoting the work of authorship of an artist (FIG. 1) is disclosed as including providing the work of authorship (FIG. 1) in response to a request for access from a requester (FIG. 1) to whom said work of authorship (FIG. 1) is released; analyzing the number of times the work of authorship has been released (FIG. 1); and limiting the number of times a work of authorship is released (FIG. 1) in response to such analysis. It is preferred for the registration of third parties to define a registered subscriber (FIG. 1) and it is preferred to receive information from the registered subscriber (FIG. 1) regarding the work of authorship (FIG. 1) and to provide a reward to the registered subscriber (FIG. 1).

### CROSS-REFERENCE TO RELATED APPLICATIONS

This application is a continuation of U.S. patent application Ser. No. 10/031,680, filed Jul. 30, 2002, which is the National Stage of International Application No. PCT/US00/20061 filed Jul. 24, 2000, which claims the benefit of U.S. Provisional Application Nos. 60/145,150 filed Jul. 22, 1999 and 60/145,153 filed Jul. 22, 1999, the disclosures of which are incorporated herein by reference in their entirety.

### FIELD OF THE INVENTION

The present invention relates generally to the field of entertainment and more particularly to methods and apparatus for providing the highest quality consumer entertainment, while promoting entertainers/artists.

### BACKGROUND OF THE INVENTION

In the past, the market for a skilled artists works (paintings) have been primarily based on the rarity of those works. The most renowned artists of the past are the artists that were most often without sufficient recognition to sell their works, hence the phrase “starving artists.” In other areas such as literature, the artist also suffered the same quandary, but the time to recognition was somewhat shorter. In any event, most artists became famous after they were deceased. In more recent years, artists have met with much more opportunity to become recognized during their lifetime and to net monetary returns. This is due to the tremendous increase in communications technology and the speed with which the market can acclaim an artist as being renown in their field.

The present day Internet download technology delivers music, music videos, literature, art, etc. This has led to the most immediate distribution of an artists works. The problem remains, however, that the artists are still using standard methods of acquiring finances to produce their works. This usually requires a formal offering and considerable promotional and legal fees. Most entertainers do not have the required funds to complete this task and produce their works as well.

Accordingly, a need exists for a means to promote works of authorship in a more efficient manner, particularly for those artists who do not have significant funds.

### SUMMARY OF THE INVENTION

The new and novel invention herein disclosed relates to a financial business process, whereby the artist can acquire the necessary finances to produce their works and keep their other costs to a minimum. In this business model, the artist makes their works available for purchase by the general public, just like any product or service. The purchaser is presented the opportunity to help the artist become recognized and possibly renown. This is accomplished by offering the purchaser the opportunity to review and comment to the artists works. The artist may then take the comments and improve their works to better meet the markets desires. In the event the artist experience an increase in the demand for their works, the artist may reward the critics for their much valued input. Artists have always judged their talent by the reviews from critics. However, it has not been the case where the artists reward their critics for their time and comments. The critics are supposed to be very knowledgeable about the art they review. They render an evaluation that the general public responds to and potentially may or may not buy the artist's works.

To implement a program that would accomplish this would be very difficult due to the nature of the critics and their desire to be independent and distinct from other critics. A more effective program would be to acquire the review from the purchaser—the people who are the real assessors of just what good art is, or at least what they want to buy.

In the past this method would have been very difficult to accomplish because of the difficulty in organization and administration. To have a few recognized art critics comment to an artists works would be easy, but to have the general public become the critics would have been nearly impossible. With the advent of the Internet, such a program can be performed and the critics are the buyers, and who would know better if the works are good. In this manner the artist can quickly determine if they have no talent or some talent that requires improvement. In this manner the market of purchasers is assured of getting satisfaction and the artists may achieve their goals with a minimum of expense.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific apparatus, system, and instrumentalities disclosed. In the drawings:

FIG. 1 is a block diagram of the computer and Internet implemented embodiment of the present invention; and

FIG. 2 is a block diagram depicting an example of one aspect of the invention in which a method of calculating rewards is depicted.

### DETAILED DESCRIPTION OF ILLUSTRATIVE EMBODIMENTS

The invention is a new computer implemented system for providing the highest quality consumer entertainment, while promoting entertainers, and doing so at the lowest cost. Using the methods of the present invention, budding talent may break into the market, being marketed to the general consumer marketplace. From this perspective, the invention serves as an interactive virtual agent/producer, marketer and management service.

In one preferred embodiment, the system is operated over the Internet where any aspiring entertainer can become a registered user and provide a short performance of their art to be viewed on the Internet. The entertainer can generate a short work as a preview of their talent, art, and attraction. The short is placed on a selection menu by the type of entertainment and made available by category. New entertainers are in the new entries menu position and prior entertainers are in the program menu. Existing entertainers are previewed by web viewers when selected from a program menu.

For purposes of the discussion herein, entertainment (a work of authorship) is divided into three basic types:
New Entertainers—New entertainers are artists who become newly registered users (RU). Such RU's are previewed in the order they enter the system. At this point, an RU is characterized as Non-Scheduled & Non-Sponsored. After a new entertainer is viewed by the Internet audience, a vote is taken to rate the either the entertainer or the entertainer's work of authorship. If the voting results are high enough, i.e., exceed some predetermined level, the entertainer is moved to the program menu area (Scheduled Program Guide). The entertainers in the program area are in competition with each other and vie for the best viewing slot (Prime Time). The assignment of time slots is accomplished by the viewers voting on the entertainers. Those entertainers with the highest voting results are placed in the most desired time slot for viewers. It is to be noted that time slots are established based on the viewers location, season of the year, etc., just as television has prime time slotting.
Existing Entertainers (new works of authorship/products)—(Scheduled Program Guide)—Existing, programmed entertainers are scheduled in an order determined by the viewers response to the quality of the performance/product. The scheduling provides better results for the entertainer, increasing their product value and providing for increased prices on their products. Additionally, the invention can provide other values to improve the entertainers position, as an incentive. The values may embrace more professional productions, additional incentives, packaging with more well known entertainers, etc. The entertainers are retained on the system for further presentations and revenue generation. Their presentation ratings are tracked, and determine their position/market value in relation to their competition (top of the chart). The entire system is dynamic and in continuous change, but contained within the system marketplace (managed), instead of an external unmonitored marketplace.
Existing Entertainers (already programmed works of authorship or old products)—(Scheduled Program Guide)—continuing promotion of present entertainers product until the viewer demand tapers off and no longer supports that product's promotion (off the chart). The product is then moved to archive storage.

It is noted that an Archives (retired or defunct product) area may also be provided. This area provides for past product review and analysis, potentially leading to new generation of products. After art product has be through the improvement stage and sales go below a certain threshold, the product may be moved to a separate area that is an archive of the history of performance and performers. This area may be useful in research. This archive may be off-line and therefore unavailable to be viewed or purchased directly. Alternatively, the contents may be online and purchasable, potentially at a discounted price due to its lack of demand, without being involved in any promotion or improvement operations.

The entertainer is provided with the required hardware and software to produce a short of their art (a local recording studio, club, etc.). As an example, the entertainer may be supplied with a suitable system comprised of audio recording equipment and/or video camera. The equipment may be integrated into a personal computer or a stand alone system. The entertainer may also be supplied with additional materials, such as a blue screen, used as a backdrop. The blue screen is provided to facilitate the insertion of background, this process being well known by those skilled in the video production art. The recorded performance, is saved in a digital format by the supplied system software and may be uploaded through the Internet to a central server. On the server the production may be processed to improve the presentation of the performance, such as adding an appropriate background. The resultant is then made available as a file that may be downloaded by a consumer interested in viewing the entertainer. The performance may also be supplied to the consumer as a streaming video in realtime.

It is within the scope of this invention that what has been referred to as Downloading may also be embodied in the functions of a Personal Storage Area located on the server. In this PSA an artists work which is purchased by the consumer can be stored for future reference. This allows the product to be stored on the data storage device, saving the consumer from having to consume local storage resources. The PSA content may be accessed by the owner as streaming content from anywhere on the Internet. This allows a consumer the ability to have all of their purchased art collection available from anywhere that has Internet access.

In the case that the performance is downloaded by the consumer for viewing, it may be in any of the digital or analog formats, also files may be viewed online as streaming data. Files may also be “saved” for later viewing in an area of the server dedicated to that particular consumer. This type of file may be provided in a highly compressed format and require a viewing software or some manner of decompressing and viewing the file. The consumer may be able to view the short performance one time or many times as determined by the control of the viewing software or system of components. The intent may be to just review the performance (sample short) or to provide an entire and complete performance as a streaming presentation. The downloaded file may also be provided in any other media such as a video disk or tape. In the case of the file being provided in any media form that can not be transferred over the Internet or any of the various communications technologies, the performance and related promotional material may be downloaded or mailed to the consumer or purchased at a store. In the event the performance is purchased at a store local to the consumer, the performance and related promotional materials is ordered over the Internet or any other media and the order processed so as to be available at a participating distributor or retailer.

In general, the consumer will be a registered user of the system before being able view a streaming presentation or to download any manner of performance. This allows each work of authorship sold to be serialized and/or registered to the specific user when purchased. A database of registered purchases will be maintained on the system to keep track of the items and the amount of reward available for that item when the holder cashes-out. The registration information, besides being stored within the database, may possibly be stored within the actual art-work-data in an encrypted digital certificate, this would possibly reduce the need to track the items which are sold to consumers.

This invention provides a system for the general public to determine the entertainers they like and provide a venue to success. Entertainers may receive financial assistance from the viewers in the form of viewers buying “air time” or “prime time”, products, contributions and donations. Viewers may make profits from these purchases. The viewers may purchase any product or service that promotes the entertainer of interest, potentially in the form of commissions. The more viewers purchase an entertainers product or streaming time, the more the entertainer is valued. This increase in entertainer revenue and apparent market value increases the worth or value of the entertainer/products. The price of the product will be increased accordingly and therefore improve the revenue of the entertainer. In this manner the entertainer may be financially capable of buying further promotion and marketing.

The viewer/buyers may “cash out” at any time and receive a reward for their purchase. The entertainer can use the viewer generated revenues for further promotion, and some of the increase in revenues due to these purchases are available as rewards to the viewer as well.

The profit increase from these purchases can be used to promote the entertainer and to package the entertainer for consideration by non-Internet promotions and producers, such as television, books, and movie productions.

The invention provides a venue for entertainers to produce their art and publish this performance over a network media. The entertainer is evaluated by the viewing consumers on a network as to their performance. If the evaluation meets some predetermined criteria of performance the entertainer will be made available to scheduled programming over the Internet or any other media. The degree of performance may also determine the order of presentation on the Internet that the program schedule is presented. This method of media management makes possible an early stage, low cost presentation of programs designed to get the entertainer in the market and to develop a market evaluation. The evaluation will help the entertainer to further their career and potentially to be produced by major entertainment providers. The following is a partial list of entertainer types:

| | |
|---|---|
| musicians | magicians |
| dancers | painters |
| movie producers | cartoonists |
| anime artists | animators |
| writers | game programmers |
| photographers | comedians |

The following is a partial list of the Multimedia Entertainment Package types:

| | |
|---|---|
| music | 3-D video |
| non-animated pictures | virtual reality worlds |
| motion pictures | device simulations |
| text data | animation |
| speech | computer software |
| MIDI scores | HTML |

Any presentation may have prerecorded or realtime content, fixed or interactive by content, view, or other. The entertainer may provide multiples of any format possibility, limited only by ones imagination.

Entertainer products may be transformed into hard media anywhere within or without the system. This means that a viewer may desire to obtain a quality print of an entertainers painting. The still picture may be transferred to printed matter at any facility capable of such printing. The prints may be offered as numbered limited editions. Audio and video may also be produced in disk format anywhere the system may communicate the digital information.

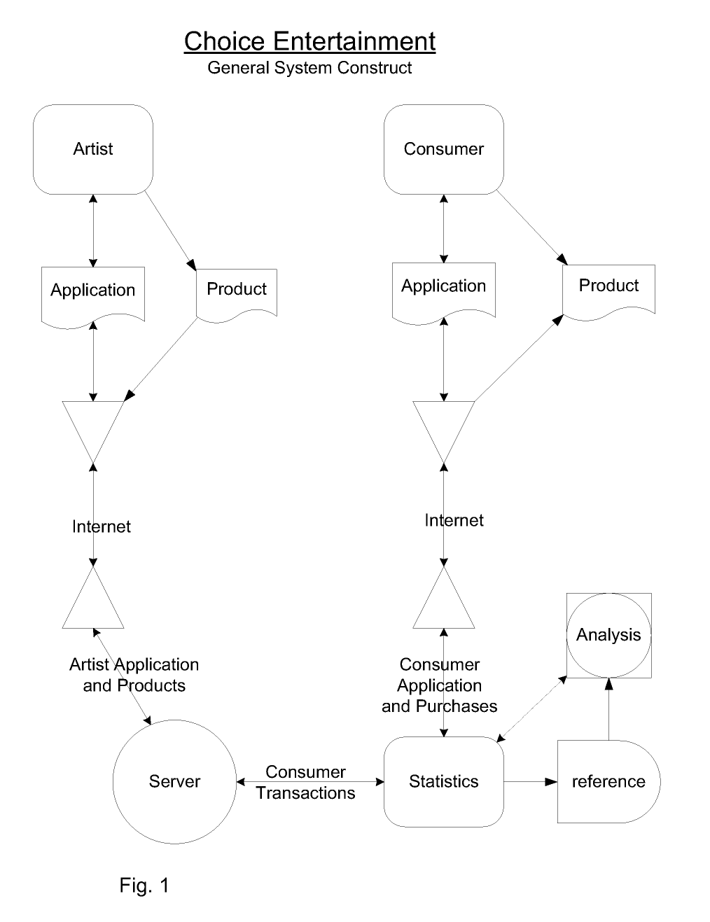

The System is comprised of two major operations. The first is the Internet system, the second is the financial operations. FIG. 1 displays the basic systems of operation for the invention. The Products are any art form, such as; music, videos, graphics, photographs, literature, etc. The three boxes labeled Statistics, reference and Analysis, operate only to assess the activities of transactions of sales and Artist Product performance.

FIG. 1 displays the basic systems of operation for CE. The Products are any art form, such as; music, videos, graphics, photographs, literature, etc. The Server (FIG. 1-S1) is a computer system that is located at and operated by the invention. The three boxes labeled Statistics (FIG. 1-S2), reference (FIG. 1-S3) and Analysis (FIG. 1-S4), operate only to assess the activities of transactions of sales and Artist Product performance.

Artist (FIG. 1-A1) is any individual or group of individuals that performs an art, this art could be any of the numerous art types. In some situations there may be an individual that takes the place of the artist, known as a Representative. For example, the Representative may be the leader of a Marching Band. The Artist or Representative must sign-up to become a member of the invention program. Once accepted, the Artist may login and upload to our art database any new art creations that will be presented to the Consumer. The Artist will also have the ability to check up on the progress of their products and manage their existing catalog of art.

Application (FIG. 1-A2) is the supporting software that gives the Artist access to CE's Server system and it's databases. This software may also perform any necessary data conversion that a given art type may require. If the artist is a Short Film Producer, then the software would convert audio and video from analog inputs into compressed digital data that would be conveyed to the invention. The application may be located at the server, on the computer at the artists location, or in both locations. The application software may be transmitted to the artists location once on initial setup, or every time the artist accesses the invention system. The application software will be customized to meet the needs of the particular type of artist who is using the invention system, supporting the specific needs of the art-form being addressed. The software may operate within the CPU of the computer located at the server, on the computer at the artists location, or in both CPU locations.

Product (FIG. 1-A3) is conveyed from the Artist (FIG. 1-A1) through the Network Interface (FIG. 1-A4,A5) via the Internet (FIG. 1-A6) to CE's Servers (FIG. 1-S1) by way of the software Application (FIG. 1-A2).

Network Interface (FIG. 1-A4,A5) is any Hardware and software overhead that is required to communicate data from one location to another across a network, which in this example is the Internet (FIG. 1-A6).

Internet (FIG. 1-A6) is the communications medium that connects the Artist to CE's Server. Presently, the Internet is the primary large scale public digital network. In the future the Internet may be abandoned and replaced with a new system. At such time, this new network will be used in place of the Internet.

### Artist Example

The Artist (FIG. 1-A1) must sign-up to become a member, i.e., registered user, of the invention program with the Application software (FIG. 1-A2). Once accepted, the Artist may login and upload to our art database any new art Product (FIG. 1-A3) that will be presented to the Consumer (FIG. 1-C1). The upload process being performed by the Application (FIG. 1-A2). Product (FIG. 1-A3) is conveyed from the Artist (FIG. 1-A1) through the Network Interface (FIG. 1-A4,A5) via the Internet (FIG. 1-A6) to CE's Servers (FIG. 1-S1) by way of the software Application (FIG. 1-A2).

### Consumer Block Diagram

Consumer (FIG. 1-C1) is any individual that purchases art, this art being any of the numerous art types. The Consumer must sign-up to become a member of the invention program. Once accepted, the Consumer may login, browse, and purchase (download) any of the works contained in the art database. The Consumer will have the ability to render a review on the products purchased. There will be a section in which the Consumer can view their current purchased products improved values and possibly cash-out at the desired time. Thus, a reward will be given to the Consumer. There is also an area where a Consumer can get a refund for a product that is unsatisfactory.

Application (FIG. 1-C2) is the supporting software that gives the Consumer access to CE's Server system and it's databases. This software may also perform any necessary data conversion that a given art type may require. If the Consumer is retrieving a Short Film, then the software would convert compressed digital data back into audio and video that would be conveyed to the Consumer. The application may be located at the server, on the computer at the Consumers location, or in both locations. The application software may be transmitted to the Consumers location once on initial setup, or every time the Consumer accesses the invention system. The application software will be customized to meet the needs of the particular art-form being accessed. The software may operate within the CPU of the computer located at the server, on the computer at the Consumers location, or in both CPU locations.

Product (FIG. 1-C3) is conveyed to the Consumer (FIG. 1-C1) through the Network Interface (FIG. 1-C4,C5) via the Internet (FIG. 1-C6) from CE's Servers (FIG. 1-S1) by way of the software Application (FIG. 1-C2).

Network Interface (FIG. 1-C4,C5) is any Hardware and software overhead that is required to communicate data from one location to another across a network, which in this example is the Internet (FIG. 1-C6).

Internet (FIG. 1-C6) is the communications medium that connects the Consumer to CE's Server. Presently, the Internet is the primary large scale public digital network. In the future the Internet may be abandoned and replaced with a new system. At such time, this new network will be used in place of the Internet.

### Consumer Example

The Consumer (FIG. 1-C1) must sign-up to become a member of the invention program with the Application software (FIG. 1-C2). Once accepted, the Consumer may login, browse, and purchase (download) any of the Product (FIG. 1-C3) contained in the art database. The download process being performed by the Application (FIG. 1-C2). Product (FIG. 1-C3) is conveyed to the Consumer (FIG. 1-C1) through the Network Interface (FIG. 1-C4,C5) via the Internet (FIG. 1-C6) from CE's Servers (FIG. 1-S1) by way of the software Application (FIG. 1-C2).

### Financial Operations

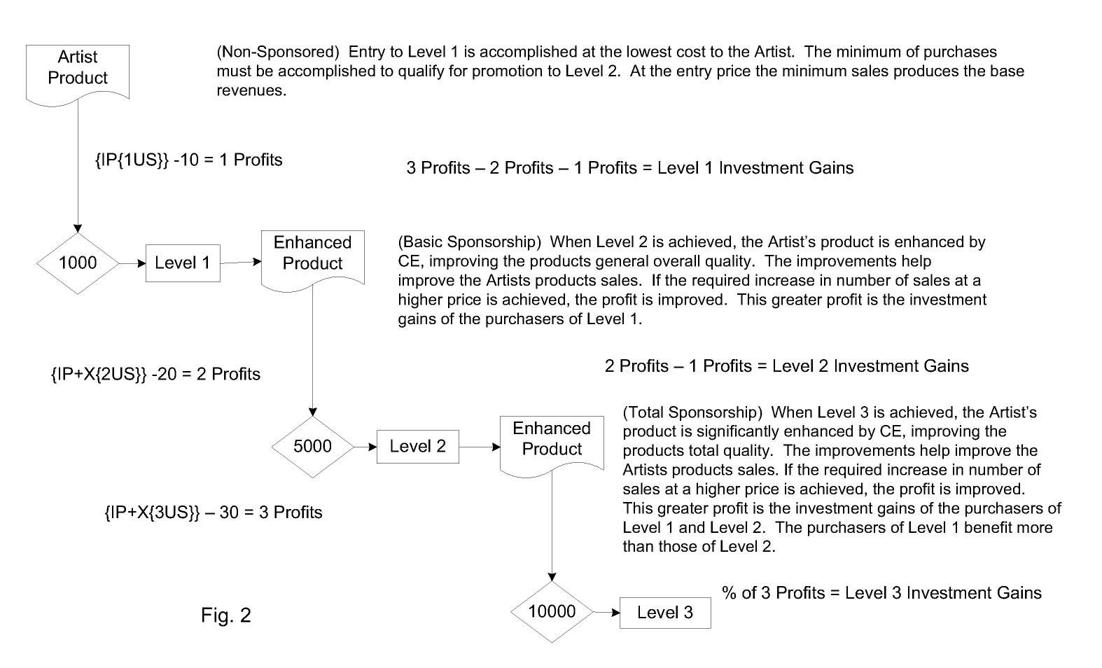

As shown below, FIG. 2 demonstrates CE's financial mechanics basic operation. Level 1 (Entry Level) consumers profit only from the gains produced by the purchases of Level 2 (Basic Sponsorship). Level 2 (Basic Sponsorship) consumers profit only from the gains produced by the purchases of Level 3 (Total Sponsorship). Note that if the Artist Product sales reach the required minimum for Level 3, Level 1 benefits from Level 2 and Level 3.

The formula legend for FIG. 2 is:

IP=Initial Product; #US=# Level Unit Sales; #O=Overhead Costs

### Financial Example

An example of the various ways that revenues may be accomplished is discussed in the following paragraph. This is only one possibility and is expressed only as an example. The structure of revenue generation for the invention is focused on product sales.

Product value is arbitrary for un-recognized entertainers. When an entertainer first generates their product, the product value is minimal. If, for instance the product is a video, it may initially be priced at $1.00. After being presented to CE's viewing community of buyers in the class of non-scheduled performances as New Entertainers, the sales rise to 10 k units in the first month. The product shows promise and is accepted into the next class now located under the Scheduled Program Guide. The sales gross $10 k and this money is utilized to package the entertainer's presentation to make it more effective on the web. After refinement, the video product is again presented in the new refined professional format. Further sales of the product occurs, but the product is now being sold at $3.00. The sales now are an additional 85 k units in the next two month. The increase of $2.00 over the original $1.00, some percentage of which is available as a “bonus” to the 10 k original purchasers of product at the $1.00 price, but only if they “resign” or “cash-out”, can they collect this money. If those who originally purchased product at $1.00 do not cash-out, they become referred to as a “sponsor/member” and continue to accrue increased value bonuses over the $1.00 sales. The 85 k unit sales produce $255 k and the invention utilizes this money to continue to improve the entertainers product, remainder made available to the performer. During the next three months (total of six months) the product sells an additional 100 k units but at $5.00 per unit. This is an additional $500 k, a $4.00 increase to those original purchasers at $1.00, and $2.00 increase for those who purchase at $3.00. This is clear as to the value for viewers to buy product early and let the value increase over time. It is to be understood that the product may be priced at any figure and that some percentage of the sales value increases are available to the involved parties, as determined by the invention.

| | Months | | | | | | | | | | | |
|---|---|---|---|---|---|---|---|---|---|---|---|---|
| Dollars | 1 | 2 | 3 | 4 | 5 | 6 | 7 | 8 | 9 | 10 | 11 | 12 |
| $7.00 | | | | | | | | | | | | |
| $6.00 | | | | | | | | | | | | |
| $5.00 | | | | 500k | → | → | | | | | | |
| $4.00 | | | | | | | | | | | | |
| $3.00 | | 100k | → | | | | | | | | | |
| $2.00 | | | | | | | | | | | | |
| $1.00 | 10K | | | | | | | | | | | |

195 k unit sales produced $765 k revenue.
If all cashed-out the invention nets ($210 k total) leaves 555 k

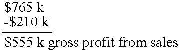

$555 k/6 months/one entertainer=$92,500/month avg.

The above is a worst case scenario. In reality, many of the product buyers will hold on to their purchases and potentially purchase more new products from the scheduled entertainer. These products will probably start at a cost of $3.00 and increase to some higher final unit cost, due to the increasing frame of the entertainer.

These figures are for just a “video product” and do not include the revenues from banner advertising or other product sales. The system is capable of presenting all artists from all artistic fields with simultaneous promotion of multiple artists competing for the “Top Ten” chart.

While the invention has been described with reference to a preferred embodiment, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. A computer implemented method for promoting a work of authorship of an artist, said method comprising the steps of:
providing a work of authorship created by an artist, in electronic form, for access;
releasing said work of authorship in response to a request for access from a requestor;
recording both the release of a work of authorship and the requester to whom said work of authorship is released;
analyzing the number of times a work of authorship has been released; and
limiting the number of times a work of authorship is released.

2. The method of claim 1, further comprising the steps of registering a requester, thereby defining a registered subscriber; and receiving information from said registered subscriber regarding said work of authorship.

3. The method of claim 2, further comprising the steps of requesting said registered subscriber to provide information regarding said work of authorship and providing a modified work of authorship, in electronic form, for access, wherein said work of authorship is modified in response to information received from said registered subscriber.

4. The method of claim 2, further comprising the step of providing a reward to said registered subscriber.

5. The method of claim 4, further comprising the step of tracking the provision of rewards.

6. The method of claim 4, wherein said step of providing a reward comprises the step of making a portion of said reward available to said registered subscriber.

7. The method of claim 4, wherein said step of providing a reward comprises the step of making a portion of said reward available to said artist.

8. The method of claim 1, wherein said step of releasing said work of authorship, comprises the step of charging said requester for releasing said work of authorship.

9. The method of claim 1, wherein said method is implemented on a server and wherein said step of releasing said work of authorship, comprises the steps of designating a portion of said server for use by said requestor, storing said work of authorship in said designated portion and charging said requestor.

10. The method of claim 8, further comprising adjusting said charge in response to said analyzing step.

11. The method of claim 1, further comprising the step of receiving a new work of authorship and providing said new work of authorship in electronic form.

12. The method of claim 1, further comprising the step of providing a preview of said work of authorship to said registered subscriber.

13. The method of claim 1, further comprising the step of providing a physical copy of said work of authorship to said registered subscriber.

14. The method of claim 13, further comprising the step of limiting the number of physical copies being provided.

15. A computer implemented method for promoting a work of authorship of an artist, said method comprising the steps of:
providing at least a portion of a work of authorship created by an artist, in electronic form, for access;
releasing at least a portion of said work of authorship in response to a request for access from a requestor;
accumulating both the release of a work of authorship and the requester to whom said work of authorship is released;
limiting the number of times a work of authorship is released in response to the total number of releases accumulated;
registering a third party, thereby defining a registered subscriber;
receiving information from said registered subscriber regarding said work of authorship; and
providing a reward to said registered subscriber.

16. The method of claim 15, wherein said step of providing a reward comprises providing at least a portion of said reward to said registered subscriber.

17. The method of claim 16, further comprising the steps of accumulating said rewards provided to said registered subscriber, receiving notification from said subscriber of a desire to receive the accumulated rewards and providing the accumulated rewards to said subscriber.

18. The method of claim 15, wherein said step of providing a reward comprises providing at least a portion of said reward to said artist.

19. The method of claim 15, wherein said step of limiting the number of times said work of authorship is released comprises setting a numerical limit, said method further comprising the steps of:
halting the release of said work of authorship after said numerical limit is reached;
defining at least a portion of the requestors as a first group;
modifying at least a portion of said work of authorship;
providing the modified work of authorship for access;
releasing at least a portion of said modified work of authorship in response to a request for access from a requester;
accumulating both the release of a work of authorship and the requestor to whom said work of authorship is released; and
providing a reward to those requestors defined as said first group.

20. The method of claim 1, wherein said step of releasing said work of authorship comprises the step of associating a serial designation to the release of said work of authorship, wherein each release of said work of authorship has a separate serial designation.
